(19) United States
(12) Patent Application Publication
(10) Pub. No.: US 2023/0407489 A1
(43) Pub. Date: Dec. 21, 2023

(54) PLANT AND PROCESS FOR OBTAINING A PREDETERMINED CARBON DIOXIDE/OXYGEN RATIO IN THE ATMOSPHERE

(71) Applicant: OBRIST TECHNOLOGIES GMBH, Lustenau (AT)

(72) Inventor: Frank Obrist, Bregenz (AT)

(21) Appl. No.: 18/035,699

(22) PCT Filed: Nov. 5, 2021
(86) PCT No.: PCT/EP2021/080700

§ 371 Date: May 5, 2023

(30) Foreign Application Priority Data
Nov. 7, 2020 (DE) 10 2020 129 375.5

(51) Int. Cl. C25B 1/04; B01D 53/04; H02S 99/00

(52) U.S. Cl. CPC C25B 1/04; B01D 53/04; H02S 99/00; B01D 2256/22; B01D 2257/504

(57) ABSTRACT

The disclosure relates to a plant, in particular power plant, for maintaining and/or balancing a predetermined carbon dioxide/oxygen ratio in atmospheric air, in particular for improving atmospheric air quality, including at least one electrolysis unit for oxygen production, connected to at least one water supply line for receiving a quantity of water and adapted to separate a received quantity of water by electrolysis into a partial quantity of oxygen and a partial quantity of hydrogen; at least one hydrogen transport unit adapted to provide the partial quantity of hydrogen for storage and/or further processing at least one carbon dioxide absorption unit for purifying ambient air of an outside atmosphere surrounding the plant, including at least one air inlet for supplying the ambient air and at least one downstream absorber unit adapted to extract a quantity of carbon dioxide from the ambient air; and at least one carbon dioxide transport unit adapted to provide the carbon dioxide quantity for storage and/or further processing, wherein the electrolysis unit includes at least one oxygen outlet for discharging the partial quantity of oxygen and the carbon dioxide absorption unit includes at least one air outlet for discharging purified ambient air, wherein the oxygen outlet and the air outlet open into the outside atmosphere.

The invention relates to a plant and a method for maintaining and/or balancing a predetermined carbon dioxide/oxygen ratio in atmospheric air, in particular for improving atmospheric air quality. Furthermore, the invention relates to a system comprising such a plant.

Since the beginning of the Industrial Revolution in 1800, atmospheric CO₂ concentrations have increased from a previously stable 280 ppmv (parts per million by volume) to 390 ppmv at the beginning of the 21st century. This increase is predicted to continue or intensify unless carbon mitigation techniques are implemented.

The ratified Paris Agreement identifies the main goal as keeping the increase in average global temperature below 2° C. above pre-industrial levels, which requires reducing CO₂ emissions to zero by 2050. Proposals to limit these emissions include the use of biofuels, solar energy and wind turbines.

The natural carbon cycle has adjusted itself over a long period of time in such a way that CO₂ is present in the atmosphere in a certain quantity. Plants play a major role in this process, absorbing the carbon from the CO₂ through photosynthesis and releasing the oxygen content back into the atmosphere. The CO₂ is thus removed from the air (over 100 billion tons of carbon are absorbed by plants in this way each year). It is well known that growing forest, especially between the ages of 10 and 40 years, is very good at absorbing the carbon from the CO₂ in the air and releasing the oxygen off to the atmosphere. Typically, such a forest on an area of one hectare releases about 15 to 30 tons of oxygen per year into the atmosphere. The amount of oxygen released depends on the type of forest (deciduous, coniferous or mixed).

The natural forest has the disadvantage that the effective CO₂ binding or oxygen production is limited to the aforementioned age period. Another limitation is the dependence of the photosynthesis process on sunlight. While the forest can bind CO₂ during daylight and thus produce oxygen, this is not possible at night. Furthermore, after trees have rotted or been cut down, new trees have to be planted again to maintain the natural CO₂ cycle. This involves a great deal of effort.

As forest cover has declined dramatically in recent decades and continues to decline, it is essential to develop new technologies that can be implemented in a short time and are capable of supporting the function of the remaining natural forest as well as at least slowing global warming.

The invention is therefore based on the task of specifying a plant that supports the natural forest in its function by means of a continuous process and thereby at least slows down global warming. Furthermore, it is the task of the invention to provide a method and a system with such a plant.

According to the invention, this task is solved with respect to the plant by the subject-matter of claim 1. With regard to the method and the system, the aforementioned task is solved by the subject matter of claim 11 (method) and claim 12 (system), respectively.

Specifically, the task is solved by a plant, in particular a power plant, for maintaining and/or balancing a predetermined carbon dioxide/oxygen ratio in atmospheric air, in particular for improving atmospheric air quality, the plant comprising:
at least one electrolysis unit for oxygen production, which is connected to at least one water supply line for receiving a quantity of water and is adapted to separate a received quantity of water by electrolysis into a partial quantity of oxygen and a partial quantity of hydrogen;
at least one hydrogen transport device adapted to provide the partial quantity of hydrogen for storage and/or further processing;
at least one carbon dioxide absorption unit for purifying ambient air of an outside atmosphere surrounding the plant, comprising at least one air inlet for supplying the ambient air and at least one downstream absorber unit adapted to extract a quantity of carbon dioxide from the ambient air; and
at least one carbon dioxide transport device adapted to provide the carbon dioxide quantity for storage and/or further processing.

The electrolysis unit has at least one oxygen outlet for discharging the partial quantity of oxygen and the carbon dioxide absorption unit has at least one air outlet for discharging purified ambient air, wherein the oxygen outlet and the air outlet open into the outside atmosphere.

The invention has several advantages. To produce oxygen for release into the outside atmosphere, the plant requires only water as the base material, which is separated into its constituent oxygen and hydrogen by an electrolysis process. This process is called water electrolysis. The electrolysis unit is connected to the water supply line to receive a quantity of water for the electrolysis process. The quantity of water may be a fresh water quantity or a desalinated quantity of sea water.

Furthermore, at least one treatment unit can be provided which treats, in particular purifies, the quantity of water before the electrolysis process.

Once the absorbed quantity of water is divided by the electrolysis unit into a partial quantity of oxygen and a partial quantity of hydrogen, the separated partial quantity of oxygen is discharged to the outside atmosphere through the oxygen outlet of the electrolysis unit. This mixes the air of the outside atmosphere with fresh oxygen and supports the natural forest in oxygen production.

The oxygen outlet can be formed by at least one line, in particular a pipeline, which extends from the electrolysis unit to the outside atmosphere. Alternatively, the oxygen outlet can be formed by a chimney through which the separated partial quantity of oxygen can be discharged into the atmosphere. At least one fan, in particular a blower, can be arranged between the electrolysis unit and the oxygen outlet for discharging the partial quantity of oxygen.

The separated partial quantity of hydrogen is provided for storage by means of the hydrogen transport device. The hydrogen transport device may be a pipeline connected to the electrolysis unit. The unit may include a hydrogen storage device that receives the partial quantity of hydrogen through the hydrogen transport device. The hydrogen transport device preferably connects the electrolysis unit to the hydrogen storage device. The hydrogen storage device may be a container, in particular a pressure vessel. Further, the hydrogen transport device is adapted to provide the partial quantity of hydrogen alternatively or additionally for further processing. It is possible that the partial quantity of hydrogen is processed together with the quantity of carbon dioxide from the extraction process to form a synthetic fuel.

The carbon dioxide absorption unit is adapted to extract a quantity of carbon dioxide from ambient air. The carbon dioxide absorption unit is therefore adapted to purify the ambient air of the outside atmosphere from carbon dioxide. For this purpose, the carbon dioxide absorption unit comprises the absorber unit adapted to extract at least an amount of carbon dioxide from ambient air. The absorber unit is preferably an amine exchanger. Other absorber units for extracting carbon dioxide from air are possible.

The carbon dioxide absorption unit has the advantage of reducing the CO₂ concentration in the atmosphere and thus bringing it closer to the original concentration before industrialization. This represents a partial function of the natural forest, so that it is further supported. Advantageously, this slows down global warming.

The carbon dioxide transport device provides the extracted carbon dioxide for storage. The carbon dioxide transport device may be a pipeline connected to the carbon dioxide absorption unit. The plant may include a carbon dioxide storage unit that receives the carbon dioxide amount through the carbon dioxide transport device. The carbon dioxide transport device may connect the carbon dioxide absorption unit to the carbon dioxide storage unit. The carbon dioxide storage unit may be a container, in particular a pressure vessel.

It is possible to remove the carbon dioxide quantity from the CO₂ cycle by permanent storage. For example, the extracted carbon dioxide quantity is storable in at least one storage facility in deeper layers of the earth. Additionally or alternatively, the carbon dioxide transport device is further adapted to provide the carbon dioxide quantity alternatively or additionally for further processing.

The plant according to the invention forms a means by which the composition of atmospheric air can be kept in equilibrium. In other words, the installation prevents an undesirable reduction in the oxygen content as well as an undesirable increase in the CO₂ content of the air. The plant according to the invention thus enables a quantity regulation of the components in the atmospheric air, so that a permanently existing quantity equilibrium of the air components in the earth's atmosphere can be maintained or an existing imbalance of the quantities of the air components can be compensated.

The invention has the further advantage that the plant can be operated continuously regardless of a time of day or night. In contrast to natural forest, which requires sunlight for photosynthesis, the plant according to the invention can continuously extract carbon dioxide from the atmosphere and continuously supply oxygen to the atmosphere. Furthermore, the oxygen output as well as carbon dioxide removal performance of the plant is substantially independent of a lifetime of the plant. By operating the plant, oxygen can be produced and carbon dioxide absorbed in a continuous process. This reliably supports the natural forest.

Particularly preferably, the plant according to the invention can be operated as a large-scale power plant in coastal regions, in particular with access to the sea or ocean, since water for oxygen production is available in very large quantities. Preferably, the plant is designed for operation in very dry areas, especially deserts. This has the advantage that such areas, in which there is no or only little vegetation, are enhanced by sensible use. The plant according to the invention essentially forms an artificial forest, which takes over a function of the natural forest and/or supports the natural forest in its function. Furthermore, in combination with a photovoltaic plant, the plant can be operated completely self-sufficient in energy, i.e. without the use of fossil fuels.

It is possible for the plant according to the invention to be used as a small power plant, for example in buildings and/or in open areas in cities, to improve air quality.

A secondary aspect of the invention relates to a method for maintaining and/or balancing a predetermined carbon dioxide/oxygen ratio in atmospheric air, in particular for improving atmospheric air quality, by a plant, in particular a plant according to the invention, in which method
a quantity of water is received by at least one electrolysis unit for oxygen production through at least one water supply line and the quantity of water received is separated by electrolysis into a partial quantity of oxygen and a partial quantity of hydrogen;
the partial quantity of hydrogen is provided by at least one hydrogen transport device for storage and/or for further processing;
ambient air of an outside atmosphere surrounding the plant is purified by at least one carbon dioxide absorption unit, wherein the ambient air is supplied through at least one air inlet to a downstream absorber unit and subsequently a quantity of carbon dioxide is extracted from the supplied ambient air by the absorber unit; and
the quantity of carbon dioxide is provided by at least one carbon dioxide transport device for storage and/or for further processing.

In the method according to the invention, the partial quantity of oxygen after separation and the purified ambient air are discharged into the outside atmosphere. This makes it possible to regulate the quantity of the constituents of the atmospheric air and thus to maintain a permanently constant quantity balance of the air constituents in the earth's atmosphere or to compensate for an existing imbalance in the quantities of the air constituents. With regard to the further advantages, reference is made to the advantages explained above in connection with the plant.

Preferred embodiments of the invention are given in the subclaims.

In a preferred embodiment, the electrolysis unit has a output capacity of a partial quantity of oxygen per year of at least 700000 tons. Preferably, the electrolysis unit is adapted to produce at least 700000 tons of oxygen per year from a quantity of water of at least 500000 tons, in particular of at least 700000 tons, in particular of 750000 tons. Compared to natural forests, which have an annual oxygen output capacity of 15 to 30 tons per hectare, the plant produces 5 times to 40 times more oxygen per year in this embodiment and with an exemplary assumed area of about 12 square kilometers.

Alternatively or additionally, the carbon dioxide absorption unit preferably has an extraction capacity of a carbon dioxide quantity per year of at least 400000 tons, in particular 600000 tons. Preferably, the carbon dioxide absorption unit is adapted to separate at least 400000 tons, in particular 600000 tons, of carbon dioxide per year from an air volume of 1450 to 1600 megatons, in particular 1570 megatons. As a result, the CO₂ concentration in the air is reduced in significant amounts by a continuous process.

In a further preferred embodiment, the electrolysis unit is adapted to separate from a quantity of water of at least 1.5 kg, in particular of at least 1.7 kg, a partial quantity of oxygen of at least 1.2 kg, in particular of at least 1.5 kg, and/or a partial quantity of hydrogen of at least 0.1 kg, in particular of at least 0.15 kg. Preferably, the electrolysis unit is adapted to separate from a quantity of water of 1.7 kg, a partial quantity of oxygen of at least 1.5 kg and a partial quantity of hydrogen of at least 0.19 kg. Advantageously, the electrolysis unit is designed to be highly efficient and to produce very large amounts of oxygen and hydrogen.

In a further preferred embodiment, the carbon dioxide absorption unit is adapted to extract from an ambient air quantity of at least 3300 kg a carbon dioxide quantity of at least 1.1 kg to 2 kg, in particular at least 1.4 kg. This enables the significant reduction of the CO₂ concentration in the air.

Preferably, the electrolysis unit and/or the carbon dioxide absorption unit each have at least one mounting area that is connectable or connected to a foundation, in particular of a building and/or structure. Through the mounting areas, the electrolysis unit and/or the carbon dioxide absorption unit are preferably firmly connected to the foundation. Alternatively, the respective unit may be connected to a separate foundation in each case.

When the plant is designed as a large-scale power plant, the electrolysis unit and/or the carbon dioxide absorption unit are designed on a large scale. The electrolysis unit and/or the carbon dioxide absorption unit may each be located in a separate operational building. The electrolysis unit and/or the carbon dioxide absorption unit may be arranged in separate operational buildings that are directly or indirectly adjacent to each other. Alternatively, the electrolysis unit and/or the carbon dioxide absorption unit may each be co-located in an operations building. A combination of separate arrangement and joint arrangement of the respective electrolysis unit and/or carbon dioxide absorption unit is possible.

The plant may have its own infrastructure. For example, the plant may include at least one access road. Further, the plant may comprise a plurality of structures. These may be, for example, industrial operating buildings. Additionally, the plant may comprise a port for ships. Furthermore, power lines may be provided to supply power to the plant, for example from a photovoltaic unit.

In the small power plant embodiment, the plant may be arranged in at least one housing. The housing may enclose the plant. The housing can be made of plastic and/or metal. Advantageously, the plant can be used in municipal buildings as part of a ventilation system or in cities to improve air quality.

Preferably, the carbon dioxide absorption unit comprises at least one chimney and at least one flow channel extending transversely to the chimney, which is connected to the chimney at a region arranged at the bottom in the installation position. The chimney preferably has the air outlet and the flow channel has the air inlet. Further preferably, the absorber unite is arranged in the flow direction between the flow channel and the chimney. The flow channel is preferably elongated and forms an area for supplying ambient air to the absorber unit. The chimney is arranged downstream of the absorber unit and discharges the purified ambient air from the absorber unit into the outside atmosphere.

The chimney can be arranged essentially perpendicular to the flow channel. The air outlet and the air inlet preferably have a height offset from each other. In other words, the air inlet and the air outlet are preferably vertically offset. The absorber unit can preferably have ambient air flowing through it. Here, it is advantageous that natural ventilation is realized by the design of the carbon dioxide absorption unit with the chimney and the flow channel, so that no electrically operated fan is required for air acceleration.

Nevertheless, it is possible that in a further embodiment a fan, in particular a blower, is provided to supply ambient air to be cleaned to the absorber unit. This may be necessary, for example, during start-up of the carbon dioxide absorption unit in order to generate the natural chimney draft in the initial phase of operation.

The at least one chimney may have a diameter between 20 meters and 30 meters and a height between 50 meters and 200 meters. The diameter of the chimney refers to the size of the air outlet. It is possible that the chimney has a larger diameter in the connection area of the flow channel than in the area of the air outlet. Preferably, the chimney has a diameter of 25 meters and a height of 100 meters. Such dimensions of the chimney enable optimized natural ventilation.

For example, with a diameter of 25 meters and a height of 100 meters of the chimney, as well as with a first temperature of the ambient air outside the absorption unit of 40° C. and a second temperature of the ambient air inside the absorption unit, in particular in the flow channel and/or in the chimney, an air ventilation or an air flow rate, in particular a purified ambient air flow rate, is achieved with a number of forty chimneys of at least 1800 megatons per year.

For solar radiation absorption, the flow channel preferably has a surface arranged at the top in the installation position, in particular a surface that is dark-colored at least in sections, in order to heat the ambient air located in the flow channel by means of radiant heat. The flow channel is preferably arranged directly below the surface arranged at the top. The surface disposed at the top in the installed position may be substantially black. The top arranged surface may be part of at least one sheet. Alternatively, it is possible that the top arranged surface is part of at least one plate. In this case, the natural ventilation for air movement between the flow channel and the chimney is further improved.

In a further embodiment, the surface arranged at the top is dark-colored at least in sections and light-colored at least in sections. This enables absorption and reflection of sunlight.

In a preferred embodiment, the surface arranged at the top is part of a planar plant area, on the long side of which several chimneys, in particular forty chimneys, are arranged in a row, with a flow channel running below the surface arranged at the top towards one of the chimneys in each case. The flow channels may each be separated from one another by a partition wall. The flow channels preferably run parallel and are part of the planar plant area. As a result, the carbon dioxide absorption unit has a space-saving and unified design.

The planar plant area can be rectangular in top view. It is also possible for the planar plant area to be circular in top view. The planar plant area is preferably directly adjacent to the other units of the plant in order to keep the lines short.

In one embodiment, the planar plant area has at least one photovoltaic unit arranged on the surface arranged above. The photovoltaic unit may be connected to the electrolysis unit for power supply. Alternatively or additionally, the photovoltaic unit may be connected to the carbon dioxide absorption unit for power supply. The photovoltaic unit may be formed as a photovoltaic array on the surface arranged above. The photovoltaic unit enables the plant to be operated self-sufficiently in terms of energy. In this context, it is advantageous that the plant is operated exclusively with electricity from solar energy and thus fossil fuels for energy generation are completely dispensed with.

A secondary aspect of the invention relates to a system for volume regulation of air constituents of the earth's atmosphere with at least one installation according to the invention and at least one power generation unit for self-sufficient power supply of the installation, wherein the power generation unit is electrically connected to the installation and uses one or more, in particular exclusively, regenerative energy sources for power generation. Reference is made here to the advantages explained in connection with the system. Furthermore, the system may alternatively or additionally have individual or a combination of several features previously mentioned in relation to the plant.

In a preferred embodiment of the system, the power generation unit comprises at least one buffer storage for storing energy. The buffer storage may be adapted to store electric power. Alternatively, the buffer storage may be adapted to store hydrogen. The buffer storage enables energy to be supplied to the system even at night, so that the system can be operated without interrupting operation.

In another preferred embodiment of the system, the power generation unit is at least one photovoltaic unit for converting solar energy into electricity. Additionally or alternatively, the power generation unit may be at least one wind power unit for converting wind energy into electricity. The wind power unit may include one or more wind turbines. Additionally or alternatively, the power generation unit may comprise at least one water power unit for converting water energy into electricity. The hydroelectric power unit may be at least one hydroelectric power plant, in particular a river power plant or pumped storage power plant. The hydroelectric power unit may additionally or alternatively comprise a wave power plant. Further, the power generation unit may additionally or alternatively be at least one thermal unit for converting thermal energy into electricity. The thermal unit may be adapted to convert heat from at least one layer of earth below the earth's surface into electricity. Other thermal units are possible.

The invention is explained in more detail below with reference to the accompanying figures. The embodiments shown represent examples of how the plant or system according to the invention can be designed.

In these show,

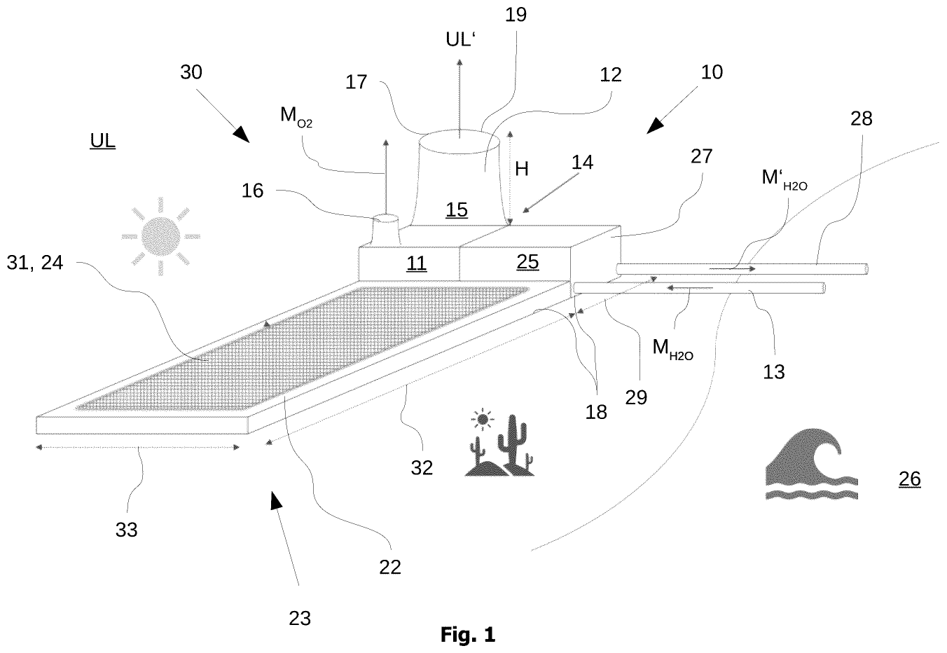

FIG. 1 perspective view of a system for maintaining and/or balancing a predetermined carbon dioxide/oxygen ratio in atmospheric air according to a preferred embodiment of the invention;

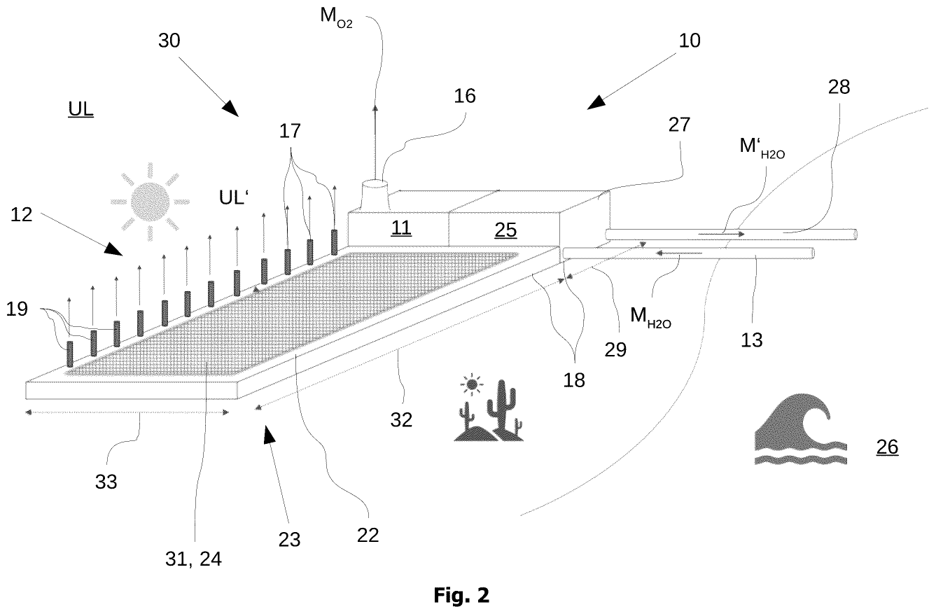

FIG. 2 perspective view of a system for maintaining and/or balancing a predetermined carbon dioxide/oxygen ratio in atmospheric air according to a further preferred embodiment of the invention;

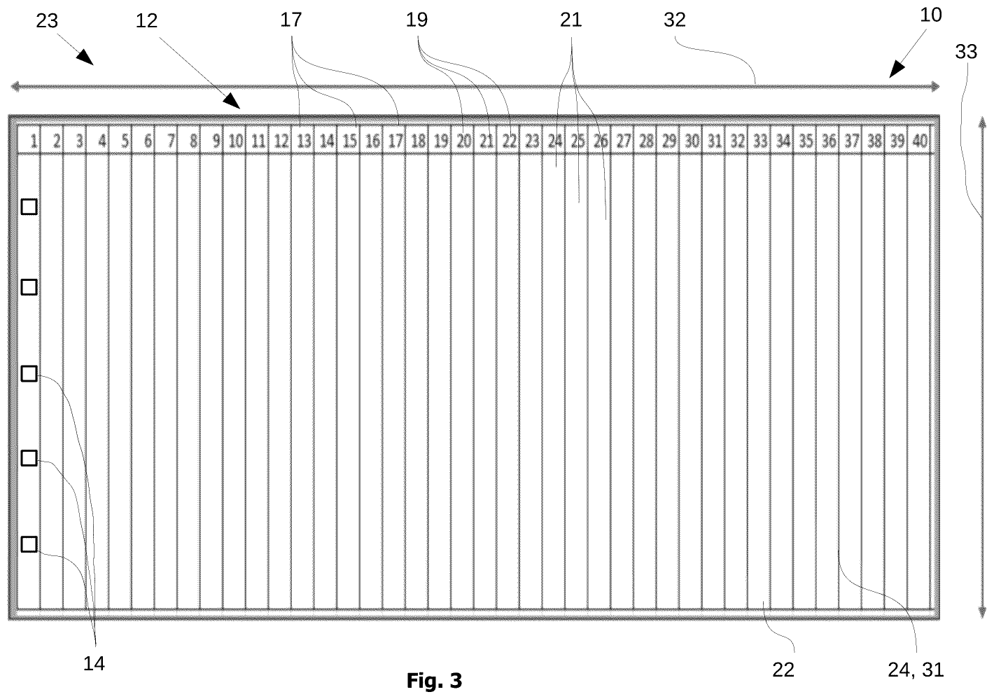

FIG. 3 top view of a planar plant section of the system according to FIG. 2; and

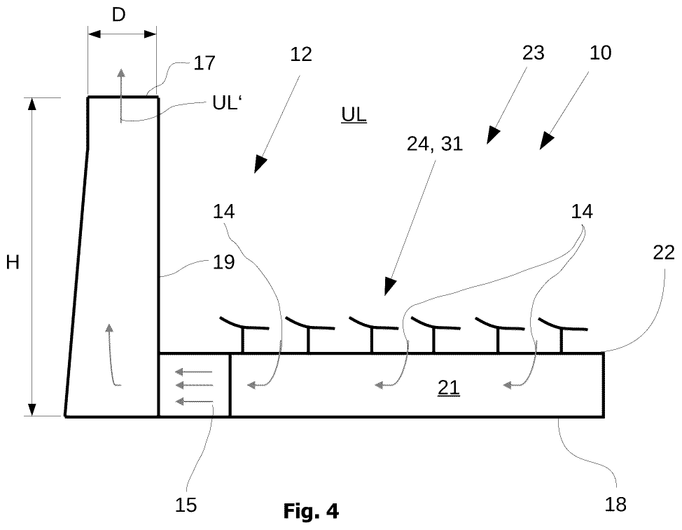

FIG. 4 schematic cross-section through the planar plant area of the system according to FIG. 3.

In the following, the same reference numerals are used for identical and identically acting parts.

FIG. 1 shows a perspective view of a system 30 for maintaining and/or balancing a predetermined carbon dioxide-oxygen ratio in atmospheric air according to a preferred embodiment of the invention. The system 30 comprises a plant 10 having an electrolysis unit 11 for producing oxygen and a carbon dioxide absorption unit 12 for purifying ambient air UL of an outside atmosphere surrounding the plant 10. Further, the system 30 comprises a power generation unit 31 for providing self-sufficient power to the plant 10, which will be discussed in more detail later.

The electrolysis unit 11 is designed to separate a quantity of water M_{H2O} by electrolysis into a partial quantity of oxygen M_{O2} and a partial quantity of hydrogen. The electrolysis unit 11 thus forms a unit for water electrolysis. The electrolysis unit 11 is connected to a water supply line 13 for receiving the quantity of water M_{H2O}. As can be seen in FIG. 1, a pump unit 25 is arranged between the electrolysis unit 11 and the water supply line 13. The pump unit 25 has at least one pump for conveying water from a water reservoir 26. The water reservoir 26 may be a sea with sea water. Alternatively, the water reservoir 26 may be a lake with fresh water. It is also possible that the water supply line 13 is connected to a river to draw fresh water for water electrolysis. In the case of the plant 10 shown in FIG. 1, the water supply line 13 is connected to a sea for taking sea water. The plant 10 is located near the coast to keep the distance to be covered to the water supply, in particular the water supply line 13 short.

The pump unit 25 is designed to pump seawater from the sea and make it available to further plant parts or units for further processing. In order to prepare the seawater for the electrolysis process by the electrolysis unit 11, the plant 10 has a seawater desalination unit 27. The seawater desalination unit 27 is connected to the pump unit 25 by at least one pipeline. The seawater desalination unit 27 is adapted to separate out a certain amount of salt from the pumped seawater M_{H2O}, so that the seawater has a reduced salt content after the desalination process by the seawater desalination unit 27. The desalinated seawater amount M_{H2O} corresponds to the quantity of water M_{H2O}, which is separated into a partial quantity of oxygen M_{O2} and a partial quantity of by the electrolysis unit 11. The electrolysis unit 11 is connected to the desalination unit 27 by at least one pipe. In order to convey the desalinated seawater from the seawater desalination unit 27 to the electrolysis unit 11, at least one further pump may be interposed.

As described above, the electrolysis unit 11 is designed to separate the absorbed quantity of water M_{H2O} into a partial quantity of hydrogen and a partial quantity of oxygen M_{O2}. Specifically, the electrolysis unit 11 has a output capacity of the partial quantity of oxygen M_{O2} per year of at least 700000 tons. To achieve this output capacity, the electrolysis unit 11 is adapted to separate a partial quantity of oxygen M_{O2} of at least 1.2 kg from an absorbed quantity of water M_{H2O} of at least 1.5 kg. Preferably, the electrolysis unit 11 is adapted to separate a partial quantity of oxygen M_{O2} of at least 1.5 kg from a quantity of water M_{H2O} of at least 1.7 kg. For discharging the produced partial quantity of oxygen M_{O2}, the electrolysis unit 11 has an oxygen outlet 16, which opens into the outside atmosphere. It is possible that the electrolysis unit 11 has one or more oxygen outlets 16 for delivering the generated partial quantity of oxygen M_{O2}. To achieve an annual output of 700000 tons of oxygen from the electrolysis unit 11, at least 500000 tons of desalinated seawater are required. To increase the quantity of water for the electrolysis process, other water supply sources are also possible.

The plant 10 further comprises at least one hydrogen transport device, not shown, which is adapted to provide the partial quantity of hydrogen separated from the quantity of water M_{H2O} for storage and/or for further processing. It is possible that the plant 10 comprises a hydrogen storage device for this purpose, which is connected to the hydrogen transport device. After the electrolysis process, the hydrogen transport device feeds the separated partial quantity of hydrogen from the electrolysis unit 11 to the hydrogen storage device. Alternatively, it is possible that the hydrogen transport device feeds the partial quantity of hydrogen to another part of the plant, which is not shown, for further processing.

Referring to FIG. 1, the carbon dioxide absorption unit 12 has an air inlet 14 for supplying ambient air UL and a downstream absorber unit 15. It is possible that the carbon dioxide absorption unit 12 comprises one or more air inlets 14. The absorber unit 15 is connected to the air inlet 14. The absorber unit 15 is adapted to extract a quantity of carbon dioxide from the ambient air UL. The carbon dioxide absorption unit 12 further comprises an air outlet 17 oriented upward in a vertical direction. The air outlet 17 is for discharging the ambient air UL′ purified from carbon dioxide. The air outlet 17 is part of a chimney 19.

Specifically, the absorber unit 15 is arranged between the air inlet 14 and the air outlet 17. In operation, the ambient air UL flows through the air inlet 14 to the absorber unit 15, which separates, in particular filters, a certain amount of carbon dioxide from the air UL, the purified ambient air UL′ flowing after the absorber unit 15 through the air outlet 17 into the outside atmosphere. Generally, it is possible that a plurality of air inlets 14, a plurality of absorber unit 15 and a plurality of air outlets 17 are provided.

Specifically, FIG. 1 shows a single chimney 19 with a height H of 200 meters, which exemplifies the external structure of the carbon dioxide absorption unit 12. The air outlet 17 opens into the outside atmosphere, as shown in FIG. 1, also like the oxygen outlet 16.

The plant 10 further comprises a carbon dioxide transport device configured to provide the carbon dioxide quantity separated from the ambient air UL to a carbon dioxide storage and/or to a further plant part of the plant 10 for further processing. It is possible that the extracted carbon dioxide quantity is processed with the separated partial quantity of hydrogen to form a common end product.

The carbon dioxide absorption unit 12 has an extraction capacity of a carbon dioxide quantity per year of at least 400000 tons, in particular 600000 tons. In other words, the carbon dioxide absorption unit 12 is adapted to purify an amount of ambient air per year of at least 1500 megatons. Specifically, the carbon dioxide absorption unit 12 is adapted to extract a carbon dioxide quantity of at least 1.4 kg from an ambient air quantity of at least 3300 kg.

Furthermore, the plant 10 according to FIG. 1 comprises a carbon dioxide transport device not shown, which is adapted to provide the separated carbon dioxide for storage and/or for further processing. For this purpose, the plant 10 may comprise a carbon dioxide storage device.

As shown in FIG. 1, the plant 10 has a planar plant area 23. The planar plant area 23 is directly connected to the electrolysis unit 11. A power generation unit 31, which is a photovoltaic unit 24, is arranged on the planar plant area 23. The photovoltaic unit 24 is connected to the respective units of the plant 10 for power supply. The photovoltaic unit 24 is adapted in such a way that the entire plant 10 or the entire system 30 can be operated self-sufficiently in terms of energy. This is to be understood as meaning that the electrical power for operating the entire plant 10 is provided exclusively by solar energy by means of the photovoltaic unit 24. In other words, no fossil energy sources are used for the operation of the plant 10.

The planar plant area 23 has a longitudinal extension 32 of about 5000 meters and a transverse extension 33 of about 2000 meters. In other words, the two-dimensional plant area of plant 10 covers an area of 10 square kilometers. The plant area shown in FIG. 1 containing the electrolysis unit 11 can have a partial longitudinal extension 29 of approximately two kilometers. Other partial longitudinal, longitudinal and transverse extents 29, 32, 33 are possible.

Assuming a total area of the system 30 or the plant 10 of approximately twelve square kilometers, the plant 10 produces at least 580 tons of oxygen per hectare (0.01 square kilometer) per year. Compared to a conventional natural forest, which releases an annual quantity of oxygen of 15 to 30 tons per hectare, the plant 10 has an oxygen output into the atmosphere that is 5 times to 40 times higher. The plant can therefore be described as an artificial forest, which has a higher oxygen output rate than a natural forest.

The seawater desalination unit 27 described above is connected to a water return line 28 through which a recirculated quantity of seawater M′_{H2O} with increased salinity is returned to the sea. Specifically, a certain salinity is extracted from the extracted quantity of seawater and then returned to the sea with a part of the extracted seawater quantity as a recirculated quantity of water M′_{H2O}. This provides a water cycle that is harmless to nature.

The preferred installation location of the system 30 or the plant 10 is near the coast of a sea. Particularly preferably, the plant 10 is set up in a desert. The plant 10 according to FIG. 1 is a large-scale power plant. The plant 10 comprises at least one mounting area 18 connected to a foundation of a building and/or a structure. Generally, it is possible that the electrolysis unit 11 and/or the carbon dioxide absorption unit 12 are arranged in a common building or in separate buildings.

The power supply unit 31 preferably includes a power storage unit, not shown, adapted to supply power to the plant 10 during nighttime operation. FIG. 2 shows, in contrast to the system 30 according to FIG. 1, a plant 10 in which the single carbon dioxide absorption unit 12 is replaced by several carbon dioxide absorption units 12. The respective carbon dioxide absorption unit 12 according to FIG. 2 has a chimney 19 and a flow channel 21 extending transversely to the chimney 19. This is clearly visible in FIG. 4, for example. The flow channel 21 is connected to the chimney 19 at a region of the chimney arranged at the bottom in the installation position. An absorber unit 15 is arranged between the flow channel 21 and the chimney 19, which is designed to extract a quantity of carbon dioxide from ambient air UL. The absorber unit 15 is formed by an amine exchanger. Other types of absorber units are possible.

As shown in FIG. 2, the chimneys 19 are arranged along the longitudinal extension 32 of the planar plant area 23. The planar plant area 23 has a surface 22 arranged at the top in the installation position. The surface 22 arranged at the top is dark-colored, at least in sections, in order to absorb solar energy. The flow channels 21 are arranged below the surface 22 arranged at the top in the installation position. A plurality of air inlets 14 are formed in the upper arranged surface 22 for supplying ambient air UL into the flow channels 21. The air inlets 14 form through openings through the upper surface 22, which are shown in FIG. 4 only at the first flow channel 21 for the sake of clarity. Likewise, the number of air inlets 14 is variable.

In operation, ambient air flows through the air inlets 14 into the flow channel 21 and then through the absorber unit 15. After the absorber unit 15, the purified ambient air UL′ flows into the chimney 19 and through the air outlet 17 into the outside atmosphere. Due to the dark-colored surface 22 arranged at the top, the ambient air located below the surface 22 in the flow channel 21 heats up during operation. The temperature of the ambient air UL in the flow channel 21 is preferably about 60° C. When the outside temperature of the ambient air UL is about 40° C., natural ventilation is generated by the arrangement of the chimney with the flow channel 21 as well as the dark-colored surface 22. In other words, no chimney or blower is necessary for the supply of the ambient air UL into the flow channel 21 as well as for the flow through the absorber unit 15 and the outflow of the purified ambient air UL′ from the chimney 19.

According to FIG. 3, a top view of the planar plant area 23 of the plant 10 according to FIG. 2 is shown. The numbering from 1 to 40 shown along the longitudinal extension 32 represents the number of chimneys 19 arranged along the longitudinal extension 32. The lines running transversely to the longitudinal extension 32 show schematic separations between the individual flow channels 21. The individual flow channels 21 are each assigned to a chimney 19. In each case, an absorber unit 15 is arranged between the flow channel 21 and the chimney 19. The longitudinal extent 32 of the two-dimensional plant area 23 is approximately 5000 meters and the transverse extent 33 of the two-dimensional plant area 23 is approximately 2000 meters. A total of forty chimneys 19 with a total of forty flow channels 21 are provided in the areal plant area 23. These have a combined output of purified ambient air UL′ of at least 1800 megatons per year.

To achieve this, the chimneys 19 have a diameter D which is 25 meters. The diameter D refers to that area of the chimney 19 in which the air outlet 17 is formed. The air outlet 17 is formed at a free end of the chimney 19. Furthermore, the respective chimney 19 has a height H of 100 meters. Thus, an optimal shape for the chimney effect for natural ventilation is formed. Other dimensions of the chimneys 19 are possible.

Furthermore, more or less than forty chimneys 19, each with an associated flow channel 21, may be arranged in the planar plant area 23. As can be seen in FIG. 4, the planar plant area 23 is provided with a photovoltaic unit 24 on the surface 22 arranged at the top. In other words, a photovoltaic unit 24 is arranged on the top arranged surface 22 of the planar plant area 23. The photovoltaic unit 24 preferably has an output of 1.5 gigawatts per year. In the system 30 according to FIG. 2, the carbon dioxide absorption unit 12 and the photovoltaic unit 24 thus spatially form a common unit. The photovoltaic unit 24 forms a power supply unit 31 for energy-autonomous operation of the entire plant 10.

It should be noted that the plants 10 described above, as well as systems 30 according to FIGS. 1 and 2, are identical except for the differences described. In the following, the method for improving atmospheric air quality by maintaining and/or balancing a carbon dioxide-oxygen ratio in atmospheric air by the plant 10 according to FIG. 1 and/or according to FIG. 2 is described in more detail.

In a first method step, a quantity of water M_{H2O} is received by means of the electrolysis unit 11 for oxygen production through the water supply line 13. Subsequently, the absorbed quantity of water M_{H2O} is separated by an electrolysis process into a partial quantity of oxygen M_{O2} and a partial quantity of hydrogen. The partial quantity of hydrogen is provided by at least one hydrogen transport device for storage or further processing.

In a second method step, ambient air UL of an outside atmosphere surrounding the plant 10 is purified by the carbon dioxide absorption unit 12. The ambient air UL is introduced, in particular sucked, into the flow channels 21 through a plurality of air inlets 14 and supplied to the downstream absorber units 15. Subsequently, the absorber units 15 extract a quantity of carbon dioxide from the supplied ambient air UL. The quantity of carbon dioxide is provided by the carbon dioxide transport device for storage or further processing. Then, the extracted partial quantity of oxygen M_{O2} is discharged to the outside atmosphere after the separation process and the purified ambient air UL′ is discharged to the outside atmosphere after the extraction of the carbon dioxide amount. This increases the oxygen content in the air and reduces the CO₂ content in the air.

### LIST OF REFERENCE SIGNS

10 plant
11 electrolysis unit
12 carbon dioxide absorption unit
13 water supply line
14 air inlet
15 absorber unit
16 oxygen outlet
17 air outlet
18 mounting area
19 chimney
21 flow channel
22 top arranged surface
23 planar plant area
24 photovoltaic unit
25 pump unit
26 water reservoir
27 sea water desalination unit
28 water return line
29 partial longitudinal extension
30 system
31 power generation unit
32 longitudinal extension
33 transverse extension
UL ambient air
UL′ purified ambient air
D diameter
H height
M_{H2O} quantity of water
M′_{H2O} recirculated quantity of water
M_{O2} partial quantity of oxygen

1-14. (canceled)

15. A plant for maintaining and balancing a predetermined carbon dioxide/oxygen ratio in atmospheric air comprising:
at least one electrolysis unit configured for oxygen production, the electrolysis unit connected to at least one water supply line for receiving a quantity of water, the electrolysis unit adapted to separate the received quantity of water by electrolysis into a partial quantity of oxygen and a partial quantity of hydrogen;
at least one hydrogen transport unit adapted to provide the partial quantity of hydrogen for storage and further processing;
at least one carbon dioxide absorption unit for purifying ambient air of an outside atmosphere surrounding the plant, the carbon dioxide absorption unit including at least one air inlet for supplying the ambient air and at least one downstream absorber unit adapted to extract a quantity of carbon dioxide from the ambient air; and
at least one carbon dioxide transport unit adapted to provide the carbon dioxide quantity for storage and further processing,
wherein the electrolysis unit includes at least one oxygen outlet for discharging the partial quantity of oxygen and the carbon dioxide absorption unit includes at least one air outlet for discharging the purified ambient air,
wherein the oxygen outlet and the air outlet open into the outside atmosphere, and
wherein a capacity of the oxygen output of the electrolysis unit is higher than the oxygen output capacity of a natural forest relative to a same assumed surface area by at least 5 times.

16. The plant according to claim 15, wherein the oxygen output capacity of the electrolysis unit is higher than the oxygen output capacity of the natural forest relative to the same assumed surface area by at least 10 times.

17. The plant according to claim 15, wherein the electrolysis unit has an output capacity of the partial quantity of oxygen per year of at least 700,000 tons and the carbon dioxide absorption unit has an extraction capacity of the carbon dioxide quantity per year of at least 400,000 tons.

18. The plant according to claim 15, wherein the electrolysis unit is adapted to separate from the water quantity of at least 1.5 kg, the partial quantity of oxygen of at least 1.2 kg, and the partial quantity of hydrogen of at least 0.1 kg.

19. The plant according to claim 15, wherein the carbon dioxide absorption unit is adapted to extract from an ambient air quantity of at least 3300 kg the carbon dioxide quantity of at least 1.1 kg.

20. The plant according to claim 15, wherein the electrolysis unit and the carbon dioxide absorption unit each have at least one mounting area which is connectable to a foundation.

21. The plant according to claim 15, wherein the carbon dioxide absorption unit includes at least one chimney and at least one flow channel which extends transversely to the chimney and is connected to the chimney at a region arranged at a bottom in an installation position, wherein the chimney includes the air outlet and the flow channel includes the air inlet and the absorber unit is arranged therebetween in a flow direction.

22. The plant according to claim 21, wherein the chimney has a diameter of between 20 meters and 30 meters, and a height of between 50 meters and 200 meters.

23. The plant according to claim 21, wherein the flow channel for solar radiation absorption has a surface arranged at a top in the installation position in order to heat the ambient air located in the flow channel by radiant heat.

24. The plant according to claim 23, wherein the arranged surface is part of a planar plant region, on the longitudinal side of which a plurality of chimneys is arranged in series, wherein the flow channel extends below the arranged surface towards each of the chimneys respectively.

25. The plant according to claim 24, wherein the planar plant region has at least one photovoltaic unit which is arranged on the arranged surface and is connected to the electrolysis unit and the carbon dioxide absorption unit for self-sufficient power supply.

26. A method for obtaining and balancing a predetermined carbon dioxide/oxygen ratio in atmospheric air comprising:
receiving a quantity of water by at least one electrolysis unit for oxygen production through at least one water supply line, the received quantity of water separated by electrolysis into a partial quantity of oxygen and a partial quantity of hydrogen;
providing, by at least one hydrogen transport unit, the partial quantity of hydrogen for storage and further processing;
purifying ambient air of an outside atmosphere surrounding the plant by at least one carbon dioxide absorption unit, wherein the ambient air is supplied through at least one air inlet to a downstream absorber unit;
subsequently extracting a carbon dioxide quantity from the supplied ambient air by the absorber unit; and
providing, by at least one carbon dioxide transport unit, the carbon dioxide quantity for storage and further processing,
wherein the partial quantity of oxygen after separation and the purified ambient air are discharged into the outside atmosphere, and
wherein a capacity of oxygen output of the electrolysis unit is higher than the oxygen output capacity of a natural forest relative to a same assumed surface area by at least 5 times.

27. A system for regulating a quantity of air constituents of an atmosphere comprising:
at least one plant for maintaining and balancing a predetermined carbon dioxide/oxygen ratio in atmospheric air; and
at least one power generation unit for self-sufficient power supply of the plant, wherein the power generation unit is electrically connected to the plant and uses one or more regenerative energy sources for power generation.

28. The system according to claim 27, wherein the power generation unit comprises at least one buffer storage for storing energy.

29. The system according to claim 27, wherein the power generation unit is one of at least one photovoltaic unit for converting solar energy into electricity, at least one wind power unit for converting wind energy into electricity, at least one hydro power unit for converting hydro energy into electricity, or at least one thermal unit for converting thermal energy into electricity.
